(19) United States
(12) Patent Application Publication
(10) Pub. No.: US 2026/0254705 A1
(43) Pub. Date: Aug. 27, 2026

(54) ACTIVE RECONFIGURABLE INTELLIGENT SURFACE APPARATUS INCLUDING A BIDIRECTIONAL SIGNAL MODULATOR

(71) Applicant: FOUNDATION OF SOONGSIL UNIVERSITY-INDUSTRY COOPERATION, SEOUL (KR)

(72) Inventors: Jun Taek OH, Seoul (KR); Ji Su KIM, Seoul (KR)

(73) Assignee: FOUNDATION OF SOONGSIL UNIVERSITY-INDUSTRY COOPERATION, Seoul (KR)

(21) Appl. No.: 19/463,854

(22) Filed: Jan. 29, 2026

(30) Foreign Application Priority Data
Feb. 27, 2025 (KR) 10-2025-0025916

(51) Int. Cl. H04L 27/36

(52) U.S. Cl. CPC H04L 27/362

(57) ABSTRACT

There is disclosed a bidirectional vector modulation apparatus capable of modulating vector signals transmitted in bidirectional directions. The disclosed bidirectional vector modulation apparatus includes four ports and operates using a signal separation/combination unit configured to change an input applied to each port by a predetermined gain and/or phase and to output the changed signal through another port.

The bidirectional vector modulation apparatus according to an exemplary embodiment may be applied to a communication device or a radar device, and may be implemented in a compact and lightweight form by using a signal separation/combination unit having a simple structure.

### CROSS-REFERENCE TO RELATED APPLICATION

This application claims priority from and the benefit of Korean Patent Application No. 10-2025-0025916 filed on Feb. 27, 2025, in the Korean Intellectual Property Office, the disclosure of which is incorporated herein by reference.

### STATEMENT REGARDING SPONSORED RESEARCH OR DEVELOPMENT

This research was supported by the National Research Foundation of Korea (NRF) funded by the Government of the Republic of Korea (Ministry of Science and ICT) under Grant No. NRF-2022R1F1A1072302.

This research was conducted with support from IDEC, including multi-project wafer (MPW) services and EDA tools.

### BACKGROUND OF THE DISCLOSURE

### Field of the Disclosure

The following embodiments relate to an active reconfigurable intelligent surface (RIS) including a bidirectional signal modulator, and more particularly to an active RIS apparatus and method capable of transmit/receive polarization switching using the bidirectional signal modulator.

### Description of the Related Art

A reconfigurable intelligent surface (RIS) is a technology capable of improving received power by extending coverage to radio shadow regions through reflection effects in non-line-of-sight, high-scattering environments, or by providing transmission effects that deliver signals from external base stations into buildings through increased electromagnetic wave transmissivity of objects.

Most RISs studied to date employ passive components and therefore do not provide signal amplification, such that the propagation distance is limited by the reflection efficiency of the RIS. In addition, the reflected beam pattern of the RIS is determined dependently on the incident beam pattern, which makes it impossible to reconfigure the beam pattern according to the environment. To address these issues, an active RIS technology employing active components to enable gain adjustment has been proposed.

FIG. 1A is a block diagram illustrating a structure of a one-port active reconfigurable intelligent surface (RIS).

In the case of a one-port active RIS (110), a signal incident through an antenna (140) is subjected to gain and phase adjustment by a reflective gain adjustment unit (120) and a bidirectional phase adjustment unit (130) and is re-radiated through the same port as an input port, resulting in low isolation between transmit and receive signals and a disadvantage that signal interference may occur.

FIG. 1B is a block diagram illustrating a structure of a two-port active reconfigurable intelligent surface (RIS).

In the case of a two-port active RIS (150), a signal incident through an antenna (170) is subjected to gain and phase adjustment by a gain/phase adjustment unit (160) and is transmitted through an output port, thereby enabling different transmit and receive polarizations of the antenna (170) and improving isolation between transmit and receive signals by reducing interference therebetween. However, even in the two-port active RIS (150), since reception is still limited to a single polarization, received signals are weakened in non-line-of-sight, high-scattering environments having multipath propagation.

### SUMMARY

The technical problem of the present invention is to improve isolation between transmit and receive signals.

The technical problem of the present invention is to improve transmit and receive signal quality in non-line-of-sight, high-scattering environments having multipath propagation.

According to an exemplary embodiment, there is disclosed a vector modulation apparatus comprising: a first signal separation/combination unit configured to receive a first vector signal and to separate the first vector signal into a first signal vector and a first carrier vector; a first signal vector gain/phase adjustment unit configured to adjust a magnitude or a phase of the separated first signal vector; a first carrier vector gain/phase adjustment unit configured to adjust a magnitude or a phase of the separated first carrier vector; and a second signal separation/combination unit configured to combine the first signal vector whose magnitude or phase has been adjusted and the first carrier vector whose magnitude or phase has been adjusted, thereby generating a modulated first vector signal.

Here, the vector modulation apparatus may further comprise a second signal vector gain/phase adjustment unit and a second carrier vector gain/phase adjustment unit, wherein the second signal separation/combination unit is configured to receive a second vector signal and to separate the second vector signal into a second signal vector and a second carrier vector, wherein the second signal vector gain/phase adjustment unit is configured to adjust a magnitude or a phase of the separated second signal vector, wherein the second carrier vector gain/phase adjustment unit is configured to adjust a magnitude or a phase of the separated second carrier vector, and wherein the first signal separation/combination unit is configured to combine the first signal vector whose magnitude or phase has been adjusted and the first carrier vector whose magnitude or phase has been adjusted to generate the modulated first vector signal.

Further, each of the first signal separation/combination unit and the second signal separation/combination unit includes four ports, and is configured to output, to a second port, a signal having one-half (½) of a magnitude of a signal input to a first port and having an identical phase; to output, to a third port, a signal having one-half (½) of the magnitude of the signal input to the first port and having a phase delayed by 90 degrees; to output, to the second port, a signal having one-half (½) of a magnitude of a signal input to a fourth port and having a phase delayed by 90 degrees; and to output, to the third port, a signal having one-half (½) of the magnitude of the signal input to the fourth port and having an identical phase.

Further, the first vector signal may be input to the first port of the first signal separation/combination unit, the first signal vector may be output from the second port of the first signal separation/combination unit, and the first carrier vector may be output from the third port of the first signal separation/combination unit.

Here, the first signal vector whose magnitude or phase has been adjusted may be input to the first port of the second signal separation/combination unit, the first carrier vector whose magnitude or phase has been adjusted may be input to the fourth port of the second signal separation/combination unit, and the modulated first vector signal may be output from the third port of the second signal separation/combination unit.

Further, each of the first signal separation/combination unit and the second signal separation/combination unit may be configured to output, to the first port, a signal having one-half (½) of a magnitude of a signal input to the second port and having an identical phase; to output, to the fourth port, a signal having one-half (½) of the magnitude of the signal input to the second port and having a phase delayed by 90 degrees; to output, to the first port, a signal having one-half (½) of a magnitude of a signal input to the third port and having a phase delayed by 90 degrees; and to output, to the fourth port, a signal having one-half (½) of the magnitude of the signal input to the third port and having an identical phase.

Further, the second vector signal may be input to the third port of the second signal separation/combination unit, the second signal vector may be output from the first port of the second signal separation/combination unit, and the second carrier vector may be output from the fourth port of the second signal separation/combination unit.

Here, the second signal vector whose magnitude or phase has been adjusted may be input to the second port of the first signal separation/combination unit, the second carrier vector whose magnitude or phase has been adjusted may be input to the third port of the first signal separation/combination unit, and the modulated second vector signal may be output from the first port of the first signal separation/combination unit.

According to another exemplary embodiment, there is disclosed an active reconfigurable intelligent surface (RIS) apparatus comprising: a circularly polarized antenna configured to receive a left-hand circularly polarized signal or a right-hand circularly polarized signal and to generate two signals having a 90-degree phase difference; a signal separation/combination unit configured to receive the two signals having the 90-degree phase difference through a first port and a fourth port, and to combine the signals input to the first port and the fourth port to output, through one of a second port or a third port, a signal having a phase identical to one of the two signals; and a bidirectional phase/gain adjustment unit configured to receive the output signal and to modulate a phase and a gain of the received signal,
wherein the signal whose phase and gain have been modulated is input to the signal separation/combination unit through one of the second port or the third port that does not output the combined signal,
wherein the signal separation/combination unit is configured to separate the modulated signal into two signals having a 90-degree phase difference and to output the two signals through the first port and the fourth port,
wherein, when the circularly polarized antenna receives the left-hand circularly polarized signal, the signals output through the first port and the fourth port are radiated as a right-hand circularly polarized signal via the circularly polarized antenna, and wherein, when the circularly polarized antenna receives the right-hand circularly polarized signal, the signals output through the first port and the fourth port are radiated as a left-hand circularly polarized signal via the circularly polarized antenna.

Here, the signal separation/combination unit may be configured to output, to the second port, a signal having one-half (½) of a magnitude of a signal input to the first port and having an identical phase; to output, to the third port, a signal having one-half (½) of the magnitude of the signal input to the first port and having a phase delayed by 90 degrees; to output, to the second port, a signal having one-half (½) of a magnitude of a signal input to the fourth port and having a phase delayed by 90 degrees; and to output, to the third port, a signal having one-half (½) of the magnitude of the signal input to the fourth port and having an identical phase.

Further, the signal separation/combination unit may be configured to output, to the first port, a signal having one-half (½) of a magnitude of a signal input to the second port and having an identical phase; to output, to the fourth port, a signal having one-half (½) of the magnitude of the signal input to the second port and having a phase delayed by 90 degrees; to output, to the first port, a signal having one-half (½) of a magnitude of a signal input to the third port and having a phase delayed by 90 degrees; and to output, to the fourth port, a signal having one-half (½) of the magnitude of the signal input to the third port and having an identical phase.

According to the present invention, isolation between transmit and receive signals can be improved.

According to the present invention, transmit and receive signal quality can be improved in non-line-of-sight, high-scattering environments having multipath propagation.

### BRIEF DESCRIPTION OF THE FIGURES

Embodiments will be described in more detail with regard to the figures, wherein like reference numerals refer to like parts throughout the various figures unless otherwise specified, and wherein:

FIG. 1A is a block diagram illustrating a structure of a one-port active reconfigurable intelligent surface (RIS).

FIG. 1B is a block diagram illustrating a structure of a two-port active reconfigurable intelligent surface (RIS).

FIGS. 2A and 2B are a conceptual diagram illustrating an operation of a signal separation/combination unit.

FIGS. 3A and 3B are a block diagram illustrating a structure of a bidirectional vector modulation apparatus using vector gain/phase adjustment units.

FIGS. 4A and 4B are a diagram illustrating another embodiment of a bidirectional phase/gain adjustment unit.

FIG. 5 is a diagram illustrating an exemplary operation of a dual circularly polarized active reconfigurable intelligent surface (RIS).

FIG. 6 is a diagram illustrating another exemplary operation of the dual circularly polarized active reconfigurable intelligent surface (RIS).

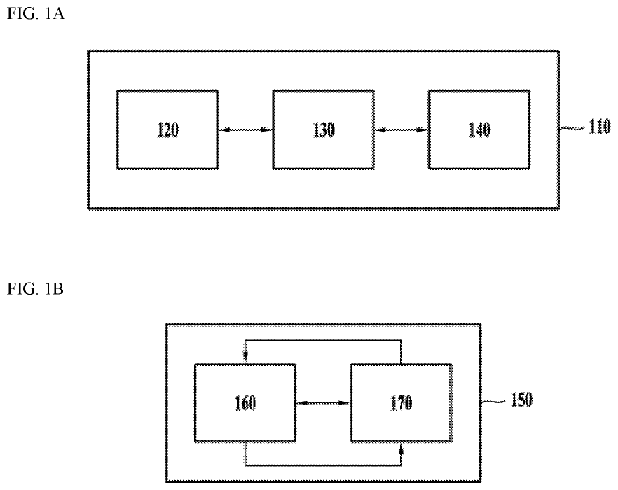

### DETAILED DESCRIPTION OF THE DISCLOSURE

Structural or functional descriptions are exemplified solely for the purpose of describing embodiments according to the concept of the present invention, and embodiments according to the concept of the present invention may be implemented in various forms and are not limited to the embodiments described herein.

Since embodiments according to the concept of the present invention may have various modifications and take various forms, the embodiments are illustrated in the drawings and described in detail herein. However, this is not intended to limit the embodiments according to the concept of the present invention to specific disclosed forms, and includes modifications, equivalents, or alternatives falling within the spirit and technical scope of the present invention.

Terms such as “first” and “second” may be used to describe various components, but the components should not be limited by these terms. These terms are used only to distinguish one component from another. For example, without departing from the scope of the present invention, a first component may be referred to as a second component, and similarly, a second component may be referred to as a first component.

When a component is referred to as being “connected to” or “coupled to” another component, it should be understood that the component may be directly connected or coupled to the other component, or intervening components may be present. In contrast, when a component is referred to as being “directly connected to” or “directly coupled to” another component, it should be understood that no intervening components are present. Expressions describing relationships between components, such as “between” and “directly between” or “adjacent to,” should be interpreted in a similar manner.

The terminology used herein is for the purpose of describing particular embodiments only and is not intended to be limiting of the present invention. As used herein, the singular forms include the plural forms unless the context clearly indicates otherwise. Further, the terms “comprise,” “include,” or “have” specify the presence of stated features, numbers, steps, operations, components, parts, or combinations thereof, but do not preclude the presence or addition of one or more other features, numbers, steps, operations, components, parts, or combinations thereof.

Unless otherwise defined, all terms used herein, including technical and scientific terms, have the same meanings as commonly understood by one of ordinary skill in the art to which the present invention belongs. Terms defined in commonly used dictionaries should be interpreted as having meanings consistent with their meanings in the context of the relevant art, and should not be interpreted in an idealized or overly formal sense unless expressly defined herein.

Hereinafter, embodiments will be described in detail with reference to the accompanying drawings. However, the scope of the patent application is not limited or restricted by these embodiments. Like reference numerals denote like elements throughout the drawings.

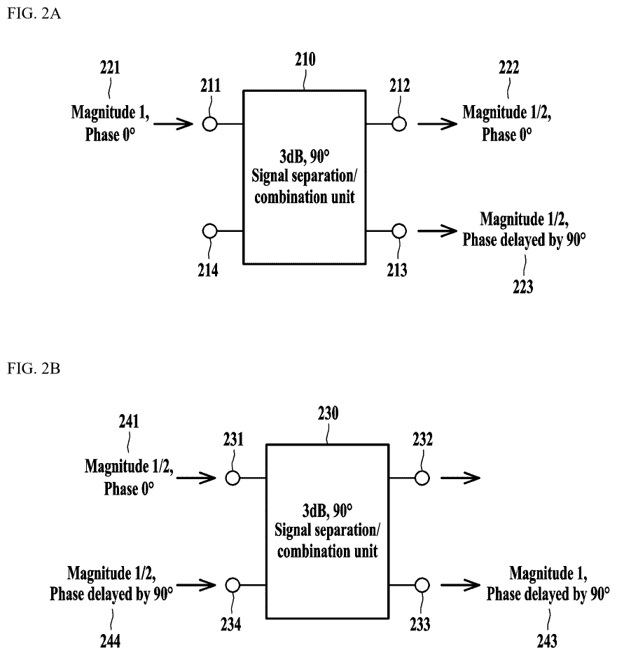

FIGS. 2A and 2B are a conceptual diagram illustrating an operation of a signal separation/combination unit.

The signal separation/combination units (210, 230) include four ports (211, 212, 213, 214) and are configured to change a magnitude and a phase of a signal input to a specific port and to output the changed signal through another port.

FIG. 2A illustrates an embodiment in which a signal input to a first port (211) is output through a second port (212) and a third port (213).

The first port (211) receives a signal (221) having a magnitude of 1 and a phase of 0 degrees. The signal received through the first port (211) is divided and output through the second port (212) and the third port (213). Among these, the second port (212) outputs a signal having one-half (½) of the magnitude and an identical phase of 0 degrees, and the third port (213) outputs a signal having one-half (½) of the magnitude and a phase delayed by 90 degrees.

FIG. 2B illustrates an embodiment in which signals input to a first port (231) and a fourth port (234) are output through a third port (233).

The first port (231) receives a signal (241) having a magnitude of one-half (½) and a phase of 0 degrees, and the fourth port (234) receives a signal (244) having a magnitude of one-half (½) and a phase delayed by 90 degrees. The signals input to the first port (231) and the fourth port (234) are combined and output through the third port (233). The third port (233) outputs a signal (243) having a magnitude of 1 and a phase delayed by 90 degrees.

In FIGS. 2A and 2B, only embodiments in which signals are input through the first port (211, 231) or the fourth port (214, 234) and output through the second port (212, 232) or the third port (213, 233) are illustrated. However, even when signals are input through the second port (212, 232) or the third port (213, 233) and output through the first port (211, 231) or the fourth port (214, 234), the signal separation/combination units (210, 230) may operate in a similar manner.

That is, when a signal input to the second port (212, 232) is output through the first port (211, 231), the magnitude is reduced to one-half (½) and the phase remains unchanged, and when the signal input to the second port (212, 232) is output through the fourth port (214, 234), the magnitude is reduced to one-half (½) and the phase is delayed by 90 degrees.

Further, when a signal input to the third port (213, 233) is output through the first port (211, 231), the magnitude is reduced to one-half (½) and the phase is delayed by 90 degrees, whereas when a signal input to the third port (213, 233) is output through the fourth port (214, 234), the magnitude is reduced to one-half (½) and the phase remains unchanged.

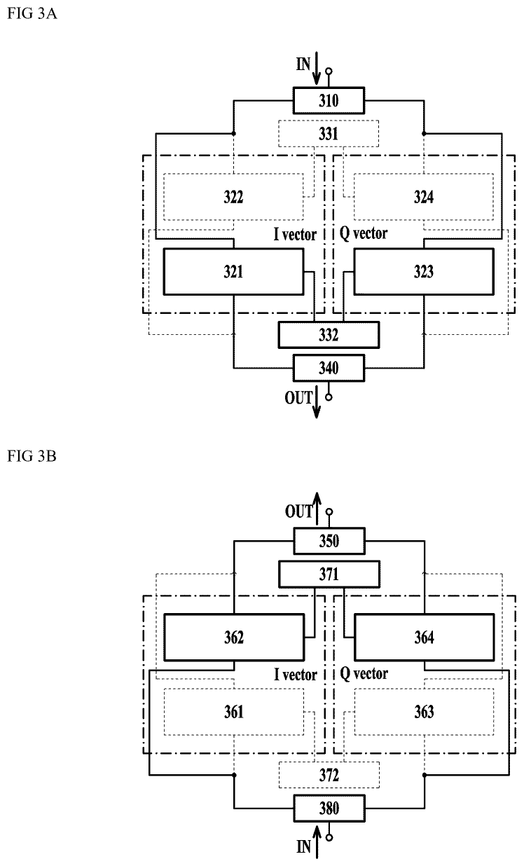

FIGS. 3A and 3B are a block diagram illustrating a structure of a bidirectional vector modulation apparatus using vector gain/phase adjustment units.

The bidirectional vector modulation apparatus includes a first signal separation/combination unit (310), a first signal vector gain/phase adjustment unit (321), a first carrier vector gain/phase adjustment unit (323), a second signal separation/combination unit (340), a second signal vector gain/phase adjustment unit (322), a second carrier vector gain/phase adjustment unit (324), and controllers (331, 332).

According to one aspect, the controllers (331, 332) may activate or deactivate the first signal vector gain/phase adjustment unit (321), the second signal vector gain/phase adjustment unit (322), the first carrier vector gain/phase adjustment unit (323), and the second carrier vector gain/phase adjustment unit (324) according to an input/output direction of a signal vector.

As illustrated in FIG. 3A, when a signal vector is input to the first signal separation/combination unit (310) and output from the second signal separation/combination unit (340), the controllers (331, 332) may activate the first signal vector gain/phase adjustment unit (321) and the first carrier vector gain/phase adjustment unit (323), and deactivate the second signal vector gain/phase adjustment unit (322) and the second carrier vector gain/phase adjustment unit (324).

The first signal separation/combination unit (310) receives a first vector signal and separates the first vector signal into a first signal vector and a first carrier vector. According to one aspect, the first signal separation/combination unit (310) may be implemented using the signal separation/combination unit (210) described with reference to FIG. 2A. In this case, the first vector signal may be input to a first port of the first signal separation/combination unit (310), the first signal vector may be output from a second port of the first signal separation/combination unit (310), and the first carrier vector may be output from a third port of the first signal separation/combination unit (310).

The first signal vector gain/phase adjustment unit (321) adjusts a magnitude or a phase of the separated first signal vector.

The first carrier vector gain/phase adjustment unit (323) adjusts a magnitude or a phase of the separated first carrier vector.

The second signal separation/combination unit (340) combines the first signal vector whose magnitude or phase has been adjusted and the first carrier vector whose magnitude or phase has been adjusted, thereby generating a modulated first vector signal. According to one aspect, the second signal separation/combination unit (340) may be implemented using the signal separation/combination unit (210) described with reference to FIG. 2B. In this case, the first signal vector may be input to a first port of the second signal separation/combination unit (340), the first carrier vector may be input to a fourth port of the second signal separation/combination unit (340), and the modulated first vector signal may be output from a third port of the second signal separation/combination unit (340).

As illustrated in FIG. 3B, when a signal vector is input to a second signal separation/combination unit (380) and output from a first signal separation/combination unit (350), controllers (371, 372) may deactivate a first signal vector gain/phase adjustment unit (361) and a first carrier vector gain/phase adjustment unit (363), and may activate a second signal vector gain/phase adjustment unit (362) and a second carrier vector gain/phase adjustment unit (364).

The second signal separation/combination unit (380) receives a second vector signal and separates the second vector signal into a second signal vector and a second carrier vector. According to one aspect, the second signal separation/combination unit (380) may be implemented using the signal separation/combination unit (230) described with reference to FIG. 2B. In this case, the second vector signal may be input to a third port of the second signal separation/combination unit (380), the second signal vector may be output from a first port of the second signal separation/combination unit (380), and the second carrier vector may be output from a fourth port of the second signal separation/combination unit (380).

The second signal vector gain/phase adjustment unit (362) adjusts a magnitude or a phase of the separated second signal vector.

The second carrier vector gain/phase adjustment unit (364) adjusts a magnitude or a phase of the separated second carrier vector.

The first signal separation/combination unit (350) combines the second signal vector whose magnitude or phase has been adjusted and the second carrier vector whose magnitude or phase has been adjusted, thereby generating a modulated second vector signal. According to one aspect, the first signal separation/combination unit (350) may be implemented using the signal separation/combination unit (210) described with reference to FIG. 2A. In this case, the second signal vector may be input to a second port of the first signal separation/combination unit (350), the second carrier vector may be input to a third port of the first signal separation/combination unit (350), and the modulated second vector signal may be output from a first port of the first signal separation/combination unit (350).

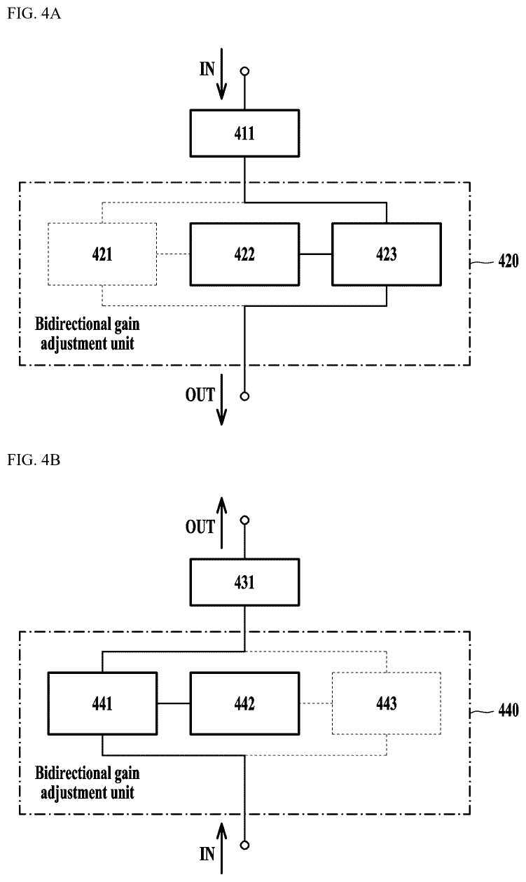

FIGS. 4A and 4B are a diagram illustrating another embodiment of a bidirectional phase/gain adjustment unit.

In FIGS. 4A and 4B, the bidirectional phase/gain adjustment unit is divided into bidirectional phase adjustment units (411, 431) and bidirectional gain adjustment units (420, 440). Further, each of the bidirectional gain adjustment units (420, 440) may include a forward gain adjustment unit (423, 443), a reverse gain adjustment unit (421, 441), and a controller (422, 442).

FIG. 4A illustrates an embodiment in which the controller (422) deactivates the reverse gain adjustment unit (421) and activates the forward gain adjustment unit (423). A signal whose phase has been modulated by the bidirectional phase adjustment unit (411) is input to the forward gain adjustment unit (423) activated by the controller (422). The forward gain adjustment unit (423) modulates a magnitude of the phase-modulated signal.

FIG. 4B illustrates an embodiment in which the controller (442) activates the reverse gain adjustment unit (441) and deactivates the forward gain adjustment unit (443). A signal is input to the reverse gain adjustment unit (441) activated by the controller (442). The reverse gain adjustment unit (441) modulates a magnitude of the signal. The signal whose magnitude has been modulated is input to the bidirectional phase adjustment unit (431), and the bidirectional phase adjustment unit (431) modulates a phase of the magnitude-modulated signal.

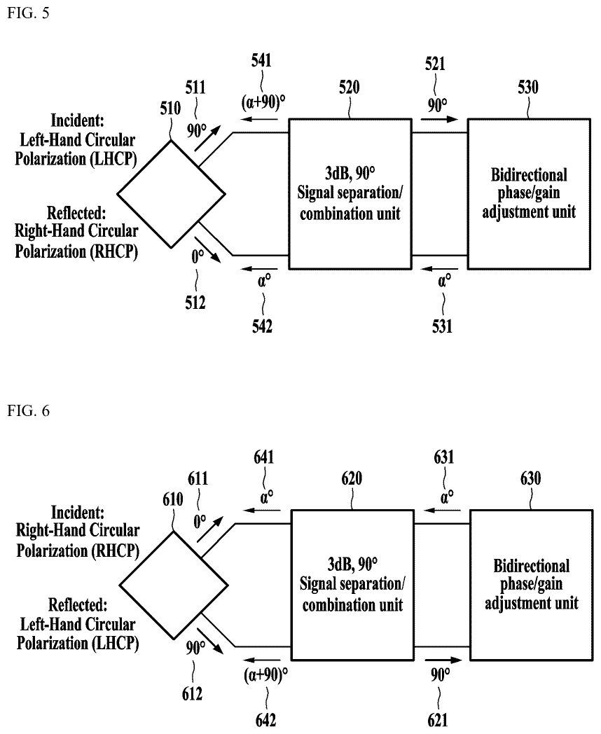

FIG. 5 is a diagram illustrating an exemplary operation of a dual circularly polarized active reconfigurable intelligent surface (RIS) that receives a left-hand circularly polarized signal and transmits a right-hand circularly polarized signal.

The dual circularly polarized active RIS of FIG. 5 includes a circularly polarized antenna (510), a signal separation/combination unit (520), and a bidirectional phase/gain adjustment unit (530).

The antenna (510) may be a circularly polarized antenna. The antenna (510) receives a left-hand circularly polarized (LHCP) signal and generates two signals (511, 512) having a 90-degree phase difference. Here, a phase of the first signal (511) may be assumed to be 90 degrees, and a phase of the second signal (512) may be assumed to be 0 degrees. The two signals (511, 512) having the 90-degree phase difference are input to two ports of the signal separation/combination unit (520).

The signals (511, 512) input to the two ports of the signal separation/combination unit (520) are combined by the signal separation/combination unit (520) and output through a single port. The combined signal (521) may have a phase of 90 degrees, similar to the first signal (511).

The combined signal (521) is input to the bidirectional phase/gain adjustment unit (530). The bidirectional phase/gain adjustment unit (530) modulates a phase and a gain of the combined signal. Accordingly, a phase of the modulated signal (531) may be an angle α.

The modulated signal (531) may be input again to one port of the signal separation/combination unit (520). The input signal is separated again by the signal separation/combination unit (520). In this case, phases of the separated signals (541, 542) may be (α+90) degrees and α degrees, respectively.

The separated signals (541, 542) may be input again to the antenna (510). In this case, the circularly polarized antenna (510) may radiate and transmit a right-hand circularly polarized (RHCP) signal.

FIG. 6 is a diagram illustrating another exemplary operation of a dual circularly polarized active reconfigurable intelligent surface (RIS) that receives a right-hand circularly polarized signal and transmits a left-hand circularly polarized signal.

The dual circularly polarized active RIS of FIG. 6 includes a circularly polarized antenna (610), a signal separation/combination unit (620), and a bidirectional phase/gain adjustment unit (630).

The antenna (610) may be a circularly polarized antenna. The antenna (610) receives a right-hand circularly polarized (RHCP) signal and generates two signals (611, 612) having a 90-degree phase difference. Here, a phase of the first signal (611) may be assumed to be 0 degrees, and a phase of the second signal (612) may be assumed to be 90 degrees. The two signals (611, 612) having the 90-degree phase difference are input to two ports of the signal separation/combination unit (620).

The signals (611, 612) input to the two ports of the signal separation/combination unit (620) are combined by the signal separation/combination unit (620) and output through a single port. The combined signal (621) may have a phase of 90 degrees, similar to the second signal (612).

The combined signal (621) is input to the bidirectional phase/gain adjustment unit (630). The bidirectional phase/gain adjustment unit (630) modulates a phase and a gain of the combined signal. Accordingly, a phase of the modulated signal (631) may be an angle α.

The modulated signal (631) may be input again to one port of the signal separation/combination unit (620). The input signal is separated again by the signal separation/combination unit (620). In this case, phases of the separated signals (641, 642) may be α degrees and (α+90) degrees, respectively.

The separated signals (641, 642) may be input again to the antenna (610). In this case, the antenna (610) may transmit a left-hand circularly polarized (LHCP) signal.

The apparatus described above may be implemented using hardware components, software components, and/or a combination of hardware components and software components. For example, the apparatuses and components described in the embodiments may be implemented using one or more general-purpose computers or special-purpose computers, such as, for example, a processor, a controller, an arithmetic logic unit (ALU), a digital signal processor (DSP), a microcomputer, an FPGA (field-programmable gate array), a PLU (programmable logic unit), a microprocessor, or any other device capable of executing and responding to instructions.

A processing device may execute an operating system (OS) and one or more software applications executed on the operating system. In addition, the processing device may access, store, manipulate, process, and generate data in response to execution of software. For ease of understanding, the processing device may be described as a single processing device; however, one of ordinary skill in the art will appreciate that the processing device may include a plurality of processing elements and/or multiple types of processing elements. For example, the processing device may include a plurality of processors or a processor and a controller. Other processing configurations, such as a parallel processor, are also possible.

Software may include a computer program, code, instructions, or a combination thereof, and may configure a processing device to operate as desired or may independently or collectively instruct the processing device. Software and/or data may be permanently or temporarily embodied in any type of machine, component, physical device, virtual device, computer storage medium or device, or in a propagated signal wave, to be interpreted by a processing device or to provide instructions or data to the processing device. Software may be distributed over networked computer systems and stored or executed in a distributed manner. Software and data may be stored in one or more computer-readable recording media.

A method according to an embodiment may be implemented in the form of program instructions executable through various computer means and recorded on a computer-readable medium. The computer-readable medium may include program instructions, data files, data structures, or combinations thereof. Program instructions recorded on the medium may be specially designed and configured for the embodiments or may be those known and available to those skilled in the computer software art. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory. Examples of program instructions include not only machine code generated by a compiler but also high-level language code executable by a computer using an interpreter or the like. The hardware devices described above may be configured to operate as one or more software modules to perform operations of the embodiments, and vice versa.

Although the embodiments have been described above with reference to limited drawings, one of ordinary skill in the art will appreciate that various modifications and variations may be made based on the above disclosure. For example, the described techniques may be performed in a different order from that described, and/or components of the described systems, structures, apparatuses, circuits, and the like may be combined or integrated in a different form from that described, or may be replaced or substituted with other components or equivalents, while still achieving appropriate results.

Accordingly, other implementations, other embodiments, and equivalents to the claims are within the scope of the following claims.

What is claimed is:

1. A vector modulation apparatus comprising:
a first signal separation/combination unit configured to receive a first vector signal and to separate the first vector signal into a first signal vector and a first carrier vector;
a first signal vector gain/phase adjustment unit configured to adjust a magnitude or a phase of the separated first signal vector;
a first carrier vector gain/phase adjustment unit configured to adjust a magnitude or a phase of the separated first carrier vector; and
a second signal separation/combination unit configured to combine the first signal vector whose magnitude or phase has been adjusted and the first carrier vector whose magnitude or phase has been adjusted, thereby generating a modulated first vector signal.

2. The vector modulation apparatus of claim 1, further comprising:
a second signal vector gain/phase adjustment unit; and
a second carrier vector gain/phase adjustment unit,
wherein the second signal separation/combination unit is configured to receive a second vector signal and to separate the second vector signal into a second signal vector and a second carrier vector,
wherein the second signal vector gain/phase adjustment unit is configured to adjust a magnitude or a phase of the separated second signal vector,
wherein the second carrier vector gain/phase adjustment unit is configured to adjust a magnitude or a phase of the separated second carrier vector, and
wherein the first signal separation/combination unit is configured to combine the first signal vector whose magnitude or phase has been adjusted and the first carrier vector whose magnitude or phase has been adjusted to generate the modulated first vector signal.

3. The vector modulation apparatus of claim 1,
wherein each of the first signal separation/combination unit and the second signal separation/combination unit includes four ports, and
wherein the signal separation/combination unit is configured to:
output, to a second port, a signal having one-half (½) of a magnitude of a signal input to a first port and having an identical phase;
output, to a third port, a signal having one-half (½) of the magnitude of the signal input to the first port and having a phase delayed by 90 degrees;
output, to the second port, a signal having one-half (½) of a magnitude of a signal input to a fourth port and having a phase delayed by 90 degrees; and
output, to the third port, a signal having one-half (½) of the magnitude of the signal input to the fourth port and having an identical phase.

4. The vector modulation apparatus of claim 3,
wherein the first vector signal is input to the first port of the first signal separation/combination unit,
wherein the first signal vector is output from the second port of the first signal separation/combination unit, and
wherein the first carrier vector is output from the third port of the first signal separation/combination unit.

5. The vector modulation apparatus of claim 3,
wherein the first signal vector whose magnitude or phase has been adjusted is input to the first port of the second signal separation/combination unit,
wherein the first carrier vector whose magnitude or phase has been adjusted is input to the fourth port of the second signal separation/combination unit, and
wherein the modulated first vector signal is output from the third port of the second signal separation/combination unit.

6. The vector modulation apparatus of claim 1,
wherein each of the first signal separation/combination unit and the second signal separation/combination unit includes four ports, and
wherein the signal separation/combination unit is configured to:
output, to a first port, a signal having one-half (½) of a magnitude of a signal input to a second port and having an identical phase;
output, to a fourth port, a signal having one-half (½) of the magnitude of the signal input to the second port and having a phase delayed by 90 degrees;
output, to the first port, a signal having one-half (½) of a magnitude of a signal input to a third port and having a phase delayed by 90 degrees; and
output, to the fourth port, a signal having one-half (½) of the magnitude of the signal input to the third port and having an identical phase.

7. The vector modulation apparatus of claim 6,
wherein the second vector signal is input to the third port of the second signal separation/combination unit,
wherein the second signal vector is output from the first port of the second signal separation/combination unit, and
wherein the second carrier vector is output from the fourth port of the second signal separation/combination unit.

8. The vector modulation apparatus of claim 6,
wherein the second signal vector whose magnitude or phase has been adjusted is input to the second port of the first signal separation/combination unit,
wherein the second carrier vector whose magnitude or phase has been adjusted is input to the third port of the first signal separation/combination unit, and
wherein the modulated second vector signal is output from the first port of the first signal separation/combination unit.

9. An active reconfigurable intelligent surface (RIS) apparatus comprising:
a circularly polarized antenna configured to receive a left-hand circularly polarized signal or a right-hand circularly polarized signal and to generate two signals having a 90-degree phase difference;
a signal separation/combination unit configured to receive the two signals having the 90-degree phase difference through a first port and a fourth port, and to combine the signals input to the first port and the fourth port to output, through one of a second port or a third port, a signal having a phase identical to one of the two signals; and
a bidirectional phase/gain adjustment unit configured to receive the output signal and to modulate a phase and a gain of the received signal,
wherein the signal whose phase and gain have been modulated is input to the signal separation/combination unit through one of the second port or the third port that does not output the combined signal,
wherein the signal separation/combination unit is configured to separate the modulated signal into two signals having a 90-degree phase difference and to output the two signals through the first port and the fourth port,
wherein, when the circularly polarized antenna receives the left-hand circularly polarized signal, the signals output through the first port and the fourth port are radiated as a right-hand circularly polarized signal via the circularly polarized antenna, and
wherein, when the circularly polarized antenna receives the right-hand circularly polarized signal, the signals output through the first port and the fourth port are radiated as a left-hand circularly polarized signal via the circularly polarized antenna.

10. The active RIS apparatus of claim 9,
wherein the signal separation/combination unit is configured to:
output, to the second port, a signal having one-half (½) of a magnitude of a signal input to the first port and having an identical phase;
output, to the third port, a signal having one-half (½) of the magnitude of the signal input to the first port and having a phase delayed by 90 degrees;
output, to the second port, a signal having one-half (½) of a magnitude of a signal input to the fourth port and having a phase delayed by 90 degrees; and
output, to the third port, a signal having one-half (½) of the magnitude of the signal input to the fourth port and having an identical phase.

11. The active RIS apparatus of claim 9,
wherein the signal separation/combination unit is configured to:
output, to the first port, a signal having one-half (½) of a magnitude of a signal input to the second port and having an identical phase;
output, to the fourth port, a signal having one-half (½) of the magnitude of the signal input to the second port and having a phase delayed by 90 degrees;
output, to the first port, a signal having one-half (½) of a magnitude of a signal input to the third port and having a phase delayed by 90 degrees; and
output, to the fourth port, a signal having one-half (½) of the magnitude of the signal input to the third port and having an identical phase.
